(19) United States
(12) Patent Application Publication
(10) Pub. No.: US 2009/0031016 A1
(43) Pub. Date: Jan. 29, 2009

(54) INTERFACE APPARATUS, MAIN APPARATUS AND CONTROL METHOD FOR USE IN THE INTERFACE APPARATUS

(75) Inventor: Hideaki Nakai, Hino-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/177,462

(22) Filed: Jul. 22, 2008

(30) Foreign Application Priority Data
Jul. 26, 2007 (JP) 2007-194830

(51) Int. Cl. G06F 15/173

(52) U.S. Cl. 709/223

(57) ABSTRACT

According to one embodiment, an interface apparatus includes a register which registers each connection ID of the plurality of communication terminals registered in a registration table of the main apparatus in a registration server on the SIP network at a predetermined registration cycle, a connector which connects among the plurality of communication terminals and the SIP network, to make communication among the plurality of communication terminals registered by the resister and the SIP network, a detector which detects a failure regarding the communication in a state where communication is made with the registration server, and a controller which makes communication with the registration server at a recovery cycle that is shorter than the registration cycle, to recover connection to the registration server, when the failure is detected.

### CROSS-REFERENCE TO RELATED APPLICATIONS

This application is based upon and claims the benefit of priority from Japanese Patent Application No. 2007-194830, filed Jul. 26, 2007, the entire contents of which are incorporated herein by reference.

### BACKGROUND

1. Field

One embodiment of the present invention relate to an interface apparatus to connect between a plurality of communication terminals each having communication functions defined by a Session Initiation Protocol (SIP), and relates to a main apparatus to house the interface apparatus therein and a control method for use in the interface apparatus.

2. Description of the Related Art

In recent years, an Internet Protocol (IP) telephone system which transmits and receives bi-directionally in real time images and voice as packet data has become widespread. The IP telephone system can perform extension communication and outside-line origination and termination among main apparatuses via the IP network as well as inter extension communication and outside-line origination and termination for each main apparatus to be connected the IP network. The IP telephone system has widely used the SIP as its protocol.

This kind of system registers a URI (connection ID) of an SIP terminal for each main apparatus in a registration server of an enterprise on an SIP network, and for making telephone calls among SIP terminals through the SIP network, makes the registration server authenticate the SIP terminals based on the registered URIs.

Meanwhile, in the system, it is fully supposed that a failure occurs in the SIP network or the registration server. As regards countermeasures to cope with the occurrence of the failure, a method for executing registration sequences to the registration server at a cycle shorter than a registration cycle after detecting the occurrence of the failure in the registration server (e.g., Jpn. Pat. Appln. KOKAI Publication No. 2006-33732).

However, the aforementioned method takes the countermeasures only to cope with the case of the occurrence of the failure in the registration server, countermeasures to cope with other occurrences of failures has been in examination stage, and the method has not attained the countermeasures yet.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a schematic configuration view of a telephone system regarding the first embodiment of the invention;

FIG. 2 is a functional block diagram of a main apparatus shown in FIG. 1;

FIG. 3 is a view depicting an example of a storage content of an SIPURI table shown in FIG. 2;

FIG. 4 is a view depicting an example of a storage content of a low cost route (LCR) table shown in FIG. 2;

FIG. 5 is a sequence view depicting transmission and reception operations of signals among a maintenance control unit, an SIP communication unit and an SIP server when abnormal data is replied from the SIP server in registering SIPURIs of the first embodiment;

FIG. 6 is a sequence view depicting transmission and reception operations of signals among the maintenance control unit, the SIP communication unit and SIP server when no response is replied from the SIP server in registering SIPURIs of the first embodiment;

FIG. 7 is a block diagram depicting in order to explain LCR originating operations of the second embodiment regarding the invention; and

FIG. 8 is a sequence view depicting transmission and reception operations of signals among the maintenance control unit, the SIP communication unit and the SIP server of the second embodiment.

### DETAILED DESCRIPTION

Various embodiments according to the invention will be described hereinafter with reference to the accompanying drawings, in general, according to one embodiment of the invention, an interface apparatus which is provided for a main apparatus to house a plurality of communication terminals therein and configured to connect a Session Initiation Protocol (SIP) network, comprising: a register which registers each connection ID of the plurality of communication terminals registered in a registration table of the main apparatus in a registration server on the SIP network at a predetermined registration cycle; a connector which connects among the plurality of communication terminals and the SIP network, to make communication among the plurality of communication terminals registered by the resister and the SIP network; a detector which detects a failure regarding the communication in a state where communication is made with the registration server; and a controller which makes communication with the registration server at a recovery cycle that is shorter than the registration cycle, to recover connection to the registration server, when the failure is detected.

### FIRST EMBODIMENT

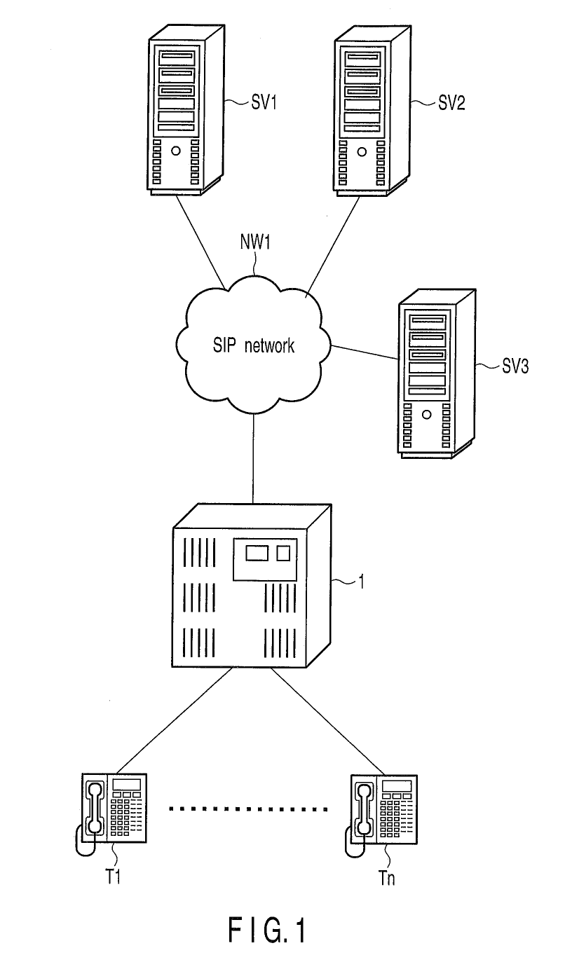

FIG. 1 shows a schematic configuration view of a telephone system of the first embodiment regarding the invention, and a reference FIG. 1 designates a main apparatus.

The main apparatus 1 houses a plurality of key telephone terminals T1-Tn (n is a natural number). SIP servers SV1-SV3 are connected to the main apparatus 1 via an SIP network NW1.

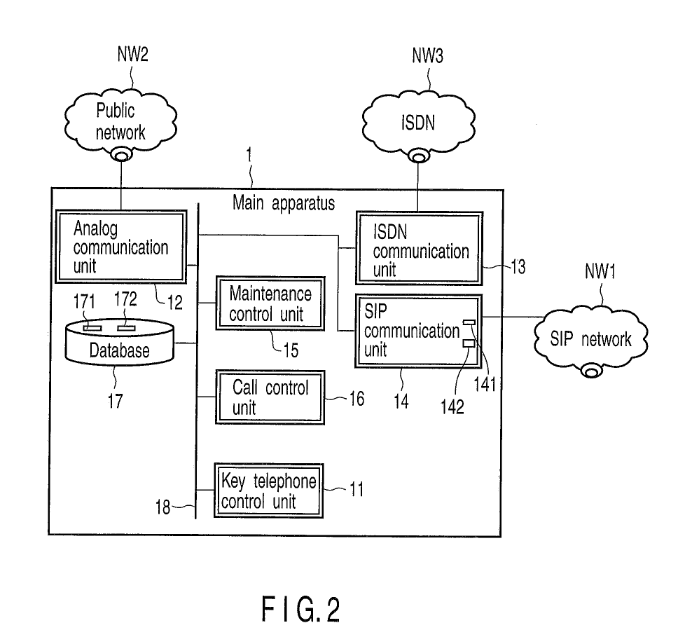

FIG. 2 shows a functional block diagram of the main apparatus 1.

The main apparatus 1 includes a key telephone control unit 11, an analog communication unit 12, an ISDN communication unit 13, an SIP communication unit 14, a maintenance control unit 15, a call control unit 16 and a database 17. These key telephone control unit 11, analog communication unit 12, ISDN communication unit 13, SIP communication unit 14, maintenance control unit 15, call control unit 16 and database 17 are mutually connected through a control bus 18. The database 17 includes an SIPURI table 171 and a low cost route (LCR) table 172.

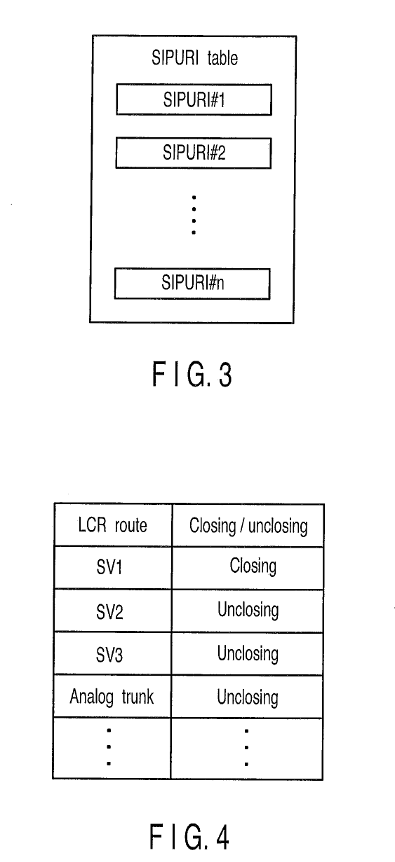

A plurality of SIPURIs added to each key telephone terminal T1-Tn from a service provider of the SIP network NW1 are stored in the SIPURI table 171, as shown in FIG. 3.

Data showing relationships between information on LCR originating routes and information on closing/unclosing of an SIP trunk, an analog trunk and an ISDN trunk are stored in the LCR table 172, as shown in FIG. 4.

The key telephone control unit 11 houses the plurality of key telephone terminals T1-Tn. The key telephone control unit 11 performs origination and termination processing and transference processing for the key telephone terminals T1-Tn.

The analog communication unit 12 performs interface processing to and from an analog public network NW2 under the control by the call control unit 16.

The ISDN communication unit 13 performs interface processing to and from an ISDN network NW3 under the control by the call control unit 16.

The SIP communication unit 14 performs interface processing to and from the SIP network NW1 under the control by the maintenance control unit 15 and the call control unit 16. The SIP communication unit 14 includes a failure monitoring unit 141 and a failure treating unit 142. The failure monitoring unit 141 monitors failure occurrence regarding the communication during communication among the SIP servers SV1-SV3.

When the failure monitoring unit 141 detects a failure, the failure treating unit 142 transmits a ‘REGISTER message’ at a recovery cycle shorter than a registration cycle of the SIPURI to the SIP servers and executes treating to the failure through the maintenance control unit 15.

The maintenance control unit 15 makes the SIP communication unit 14 register all the SIPURIs registered in the SIPURI table 171 into the SIP server SV1-SV3 on the SIP network NW1 at a predetermined registration cycle. In failure occurrence regarding the communication on the SIP network NW1, the maintenance control unit 15 sets the relevant LCR originating route in the LCR table 172 to ‘closing’. After failure recovering, the maintenance control unit 15 sets the relevant LCR originating route in the LCR table 172 to ‘unclosing’.

The call control unit 16 includes a usual control function for origination processing accompanied by a call request from each key telephone terminal T1-Tn, for usual termination processing and transference processing among the key telephone terminals T1-Tn, etc.

Next, operations of the system configured as given above will be described.

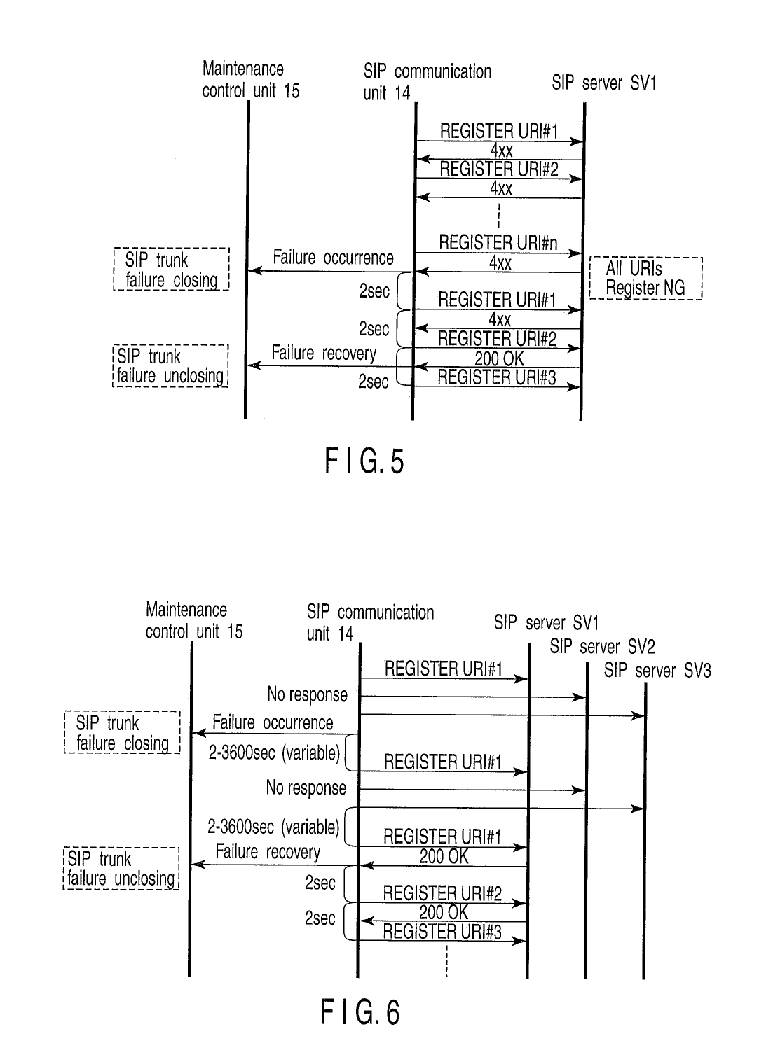

FIG. 5 shows a sequence view illustrating transmission and reception operations of signals among the maintenance control unit 15, the SIP communication unit 14 and the SIP server SV1 in a case in which the SIP server SV1 replies abnormal data in registering the SIPURIs.

Firstly, the SIPURI which is preset in the SIPURI table 171 of the main apparatus 1 has to update its registration state before the registration cycle expires, so that the SIP communication unit 14 transmits the ‘REGISTER message’ to the SIP server SV1 disposed on the network (SIP network NW1) of the service provider.

When receiving any response for the ‘REGISTER message’ from the SIP server SV1, the SIP communication unit 14 obtains the next SIPURI from the SIPURI table 171 to transmit the ‘REGISTER message’ related to the relevant SIPURI to the SIP server SV1. This processing is executed in turn to all the SIPURIs set in the SIPURI table 171.

Conclusively, when error response (4xx in FIG. 5) is received from the SIP server SV1 for the ‘REGISTER message’ related to all the SIPURIs set in the SIPURI table 171, the SIP communication unit 14 transmits a ‘Failure occurrence message’ to the maintenance control unit 15.

When receiving the ‘Failure occurrence message’, the maintenance control unit 15 updates the LCR table 172 so as to bring the closing state of the corresponding-SIP trunk into ‘closing’ and make the origination and termination operation through this SIP trunk unusable.

The SIP communication unit 14 transmits the ‘REGISTER message’ to all the SIPURIs in turn at a recovery cycle (two seconds interval) shorter than the Registration cycle regardless the Registration cycle set in the database 17.

After this, when receiving a ‘200 OK message’ from the SIP server SV1, the SIP communication unit 14 transmits a ‘Failure recovery message’ to the maintenance control unit 15, updates the closing state of the corresponding-SIP trunk in the LCR table 172 into ‘unclosing’, and makes the originating and terminating operation through this trunk usable.

As mentioned above, in the case in which all the SIPURIs have failed to be registered, the relevant SIP trunk cannot be used under normal conditions until re-registration processing ends normally at the expiration time of the registration cycle. However, the SIP communication unit 14 continues re-registration processing at the recovery cycle which is shorter than the original registration cycle for recovering of registration NG of all the SIPURIs in occurrence of a failure, so that the SIP communication unit 14 may quickly recover the registration failure state of the SIPURIs.

FIG. 6 shows a sequence view illustrating transmission and reception operations of signals among the maintenance control unit 15, the SIP communication unit 14 and the SIP servers SV1-SV3 in the case where no response is replied from the SIP server SV1 in registering the SIPURIs.

At first, since it is needed for the SIPURIs which have been preset in the SIPURI table 171 of the main apparatus 1 to update its registration state before the registration cycle is expired, the SIP communication unit 14 transmits the ‘REGISTER messages’ to the SIP servers SV1-SV3 disposed on the network (SIP network NW1) of the service provider.

In a case in which any response for the ‘REGISTER messages’ from the SIP servers SV1-SV3 cannot be received due to a network failure or the failure in the SIP servers SV1-SV3, etc., the SIP communication unit 14 interrupts the registration processing to transmit a ‘Failure occurrence message’ to the maintenance control unit 15.

When receiving the ‘Failure occurrence message’, the maintenance control unit 15 updates the closing state of the relevant SIP trunk in the LCR table 172 to ‘closing’ and makes the originating and terminating operation through this trunk unusable.

The SIP communication unit 14 performs in turn the ‘REGISTER messages’ to all the SIPURIs at a recovery cycle (2-3600 seconds intervals) that is shorter than the registration cycle which has been set in the database 17 in order to recover the registration failure state.

After this, when receiving the ‘200 OK message’ from the SIP server SV1, the SIP communication unit 14 transmits the ‘Failure recovery message’ to the maintenance control unit 15, updates the closing state of the corresponding-SIP trunk in the LCR table 172 into ‘unclosing’, and makes the originating and terminating operations through this truck usable.

As given above, in the case where the registration of all the SIPURIs results in failure due to the network failure and failures of the SIP servers SV1-SV3, although the origination and termination in relation to the corresponding-SIPURI cannot be performed generally until the re-registration processing to be performed at the expiration of the registration cycle, since the SIP communication unit 14 continues to perform the re-registration processing for each fixed time period by applying the registration cycle for failure recovery detection, the main apparatus 1 may easily detect the recovery of the failure state and may quickly recover the registration failure state of the corresponding-SIPURI.

As mentioned above, in the first embodiment, in the main apparatus 1, in the case in which a failure occurs in registering the SIPURI into the SIP server SV1 to result in failure of registration of the SIURI to be set in the SIPURI table 171, the main apparatus 1 automatically executes the registration processing of the SIPURI in the SIP server SV1 at the recovery cycle which is shorter than the registration cycle without waiting for the next registration cycle.

Accordingly, for example, in a case that the failure of the SIP server SV1 or SIP network NW1 is a temporal one and the failure is recovered later, or in a case that the failure is changed into a normal state by the replacement of a component of the SIP server SV1, the main apparatus 1 may quickly recover the connection to the SIP server SV1 without waiting for a recovery operation of a maintenance person.

In the first embodiment, the telephone system may vary the recovery cycle for each cause of the failure occurrence to perform optimum recovery processing by executing registration processing of the SIPURI to the SIP server SV1 at a recovery cycle (two seconds) in a case where the SIP server SV1 replies abnormal data, and by executing registration processing of the SIPURI in the SIP server SV1 as a long recovery cycle (3600 seconds) in a case where the SIP server replies no response, namely, in a case the SIP server SV1 is completely damaged.

### SECOND EMBODIMENT

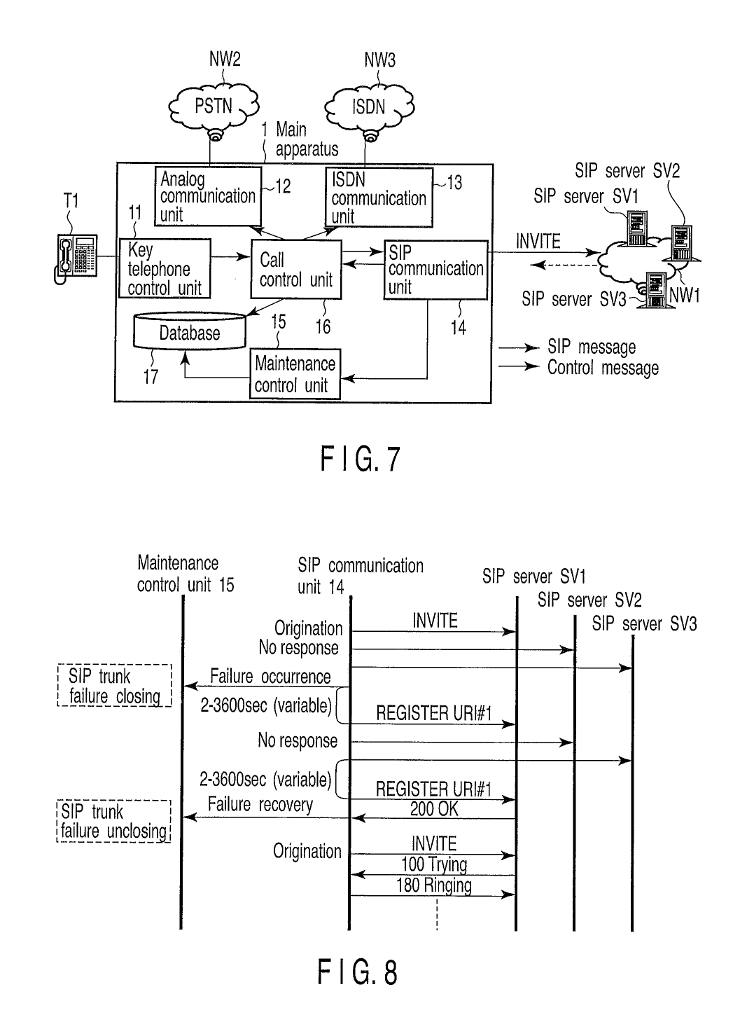

FIG. 7 shows a block diagram for explaining LCR originating operations of the second embodiment regarding the invention and FIG. 8 shows a sequence view illustrating transmission and reception operations of signals among a maintenance control unit 15, a SIP communication unit 14 and SIP servers SV1-SV3 in LCR origination.

In FIG. 7, it is assumed that LCR originating operations are performed by a key telephone terminal T1 housed in a main apparatus 1. Then, in the main apparatus 1, a call control unit 16 obtains all trunks capable of being grasped in accordance with the order of priority from an LCR table 172 based on dial information input from the key telephone terminal T1. As a result, if a first route is an SIP trunk, the call control unit 16 transmits an ‘originating connection message’ to the SIP communication unit 14.

The SIP communication unit 14 transmits an ‘INVITE message’ to the SIP server SV1; however if any response cannot be received from the SIP server SV1 after passing a fixed time period, the SIP communication unit 14 transmits the ‘INVITE messages’ to the SIP servers SV2, SV3.

Conclusively, if any response for the ‘INVITE message’ cannot be received from all the SIP servers SV1-SV3, the SIP communication unit 14 transmits a ‘Failure occurrence message’ to the maintenance control unit 15, and reports SIP trunk origination NG to the call control unit 16.

When receiving the SIP trunk origination NG, the call control unit 16 grasps the trunk of the next priority to try origination again. In a case that the kind of this trunk is an analog public network NW2, the call control unit 16 transmits an ‘origination connecting message’ to an analog communication unit 12, and in a case that the kind of this trunk is an ISDN network NW 3, the call control unit 16 transmits the ‘origination connecting message’ to an ISDN communication unit 13. The maintenance control unit 15 which has received the ‘Failure occurrence message’ updates the closing state of the corresponding-SIP trunk in the LCR table 172 into ‘closing’, makes origination and termination operations through this trunk unusable.

When the key telephone terminal T1 performs LCR origination again, since the SIP trunk in a first route is in a ‘closing’ state, the call control unit 16 immediately uses a trunk later than a second route to execute origination processing.

The SIP communication unit 14 transmits the ‘REGISTER messages’ to all the SIPURIs in turn, in accordance with a registration cycle for recovery detection which has been set in a database 17 in order to detect the recovery of the failure state.

After this, when receiving a ‘200 OK message’ from the SIP server SV1, the SIP communication unit 14 transmits a ‘Failure recovery message’ to the maintenance control unit 15, updates the closing state of the SIP trunk in the LCR table 172 into ‘unclosing’, and makes an originating and terminating operation through the trunk usable.

Thereby, in LCR origination after this, the SIP trunk that is the first route becomes able to perform the originating connection as usual.

As given above, according to the second embodiment, in the main apparatus 1, if any failure occurs on a route selected in LCR origination, in a case in which an SIP trunk is selected in LCR origination by changing setting information corresponding to the relevant route in the LCR table 172, it is easy to determine a possibility of origination by referring to the LCR table 172, and it becomes able to immediately perform route bypass to a trunk which has been set after the next priority. Since the telephone system continuously transmits the ‘REGISTER message’ to the SIP servers SV1-SV3 again at the recovery cycle to the failure occurrence route, it becomes able to easily detect the recovery of the failure state.

### OTHER EMBODIMENTS

The invention is not limited to the aforementioned embodiments. For instance, while the second embodiment has described the example which selects the SIP network, analog public network and ISDN network as an origination route, a communication line requesting for a new communication protocol other than the SIP network, analog public network, and ISDN network may be connected to the main apparatus.

While each embodiment has described the example housing the key telephone terminal in the main apparatus, a communication terminal such as a personal computer with a telephone application mounted thereon is a possible approach.

Other than this, the kind of telephone system, a functional configuration of the main apparatus, the kind of the telephone terminal to be housed in the main apparatus, a procedure and its content of recovery control for the failure, etc., may be embodied in various forms without departing from the spirit or scope of the generic inventive concept of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An interface apparatus which is provided for a main apparatus to house a plurality of communication terminals therein and configured to connect a Session Initiation Protocol (SIP) network, comprising:
a register which registers each connection ID of the plurality of communication terminals registered in a registration table of the main apparatus in a registration server on the SIP network at a predetermined registration cycle;
a connector which connects among the plurality of communication terminals and the SIP network, to make communication among the plurality of communication terminals registered by the resister and the SIP network;
a detector which detects a failure regarding the communication in a state where communication is made with the registration server; and
a controller which makes communication with the registration server at a recovery cycle that is shorter than the registration cycle, to recover connection to the registration server, when the failure is detected.

2. The interface apparatus according to claim 1, wherein:
the detector detects the failure when the registration server replies abnormal data to the registration of the connection IDs, and
the controller executes the registration of the connection IDs into the registration server at the recovery cycle, when the failure has been detected.

3. The interface apparatus according to claim 1,
wherein the detector detects the failure when the registration server replies no response to the registration of the connection IDs.

4. The interface apparatus according to claim 1, wherein:
when a user of the communication terminal performs an originating operation,
the detector detects the failure when the registration server replies no response.

5. The interface apparatus according to claim 1, wherein:
the controller recovers the connection to the registration server by making communication with the registration server at a first recovery cycle when the registration server replies abnormal data, and recovers the connection to the registration server by making communication with the registration server at a second recovery cycle which is different from the first recovery cycle when the registration server replies no response.

6. A main apparatus which houses a plurality of communication terminals and is configured to connect a Session Initiation Protocol (SIP) network, comprising:
a register which registers each connection ID of the plurality of communication terminals registered in a registration table into a registration server on the SIP network at a predetermined registration cycle;
a connector which connects among the plurality of communication terminals and the SIP network, to make communication among the plurality of communication terminals registered by the resister and the SIP network;
a detector which detects a failure regarding the communication in a state where communication is made with the registration server; and
a controller which makes communication with the registration server at a recovery cycle that is shorter than the registration cycle, to recover connection to the registration server, when the failure is detected.

7. The main apparatus according to claim 6, wherein:
the detector detects the failure when the registration server replies abnormal data to the registration of the connection IDs, and
the controller executes the registration of the connection IDs into the registration server at the recovery cycle, when the failure has been detected.

8. The main apparatus according to claim 6,
wherein:
the detector detects the failure when the registration server replies no response to the registration of the connection IDs.

9. The main apparatus according to claim 6, wherein:
when a user of the communication terminal performs an originating operation,
the detector detects the failure when the registration server replies no response.

10. The main apparatus according to claim 6, wherein:
the controller recovers the connection to the registration server by making communication with the registration server at a first recovery cycle when the registration server replies abnormal data, and recovers the connection to the registration server by making communication with the registration server at a second recovery cycle which is different from the first recovery cycle when the registration server replies no response.

11. The main apparatus according to claim 6, further comprising:
a memory which stores a route table in which a plurality of originating routes to the registration server are associated with setting information showing closing and unclosing, wherein
the controller updates setting information corresponding to an originating route with a failure caused therein in the route table into closing, and recovers a faulty route at the recovery cycle.

12. The main apparatus according to claim 11, wherein
the controller updates setting information corresponding to the originating route with the failure caused therein in the route table into unclosing, when a faulty route is recovered.

13. A control method for use in an interface apparatus which is provided for a main apparatus to house a plurality of communication terminals therein and configured to connect a Session Initiation Protocol (SIP) network, comprising:
registering each connection ID of the plurality of communication terminals registered in a registration table of the main apparatus into a registration server on the SIP network at a predetermined registration cycle;
connecting among the plurality of communication terminals and the SIP network, to make communication among the plurality of communication terminals registered by the registering and the SIP network;
detecting a failure regarding the communication in a state where communication is made with the registration server; and
making communication with the registration server at a recovery cycle which is shorter than the registration cycle, to recover connection to the registration server when the failure is detected.
